(19) United States
(12) Patent Application Publication
(10) Pub. No.: US 2010/0231097 A1
(43) Pub. Date: Sep. 16, 2010

(54) Micro-Motor

(76) Inventors: Alex Horng, Kaohsiung (TW); I-Yu Huang, Kaohsiung (TW); Guan-Ming Chen, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/402,555

(22) Filed: Mar. 12, 2009

(51) Int. Cl. H02K 5/16

(52) U.S. Cl. 310/400

(57) ABSTRACT

A micro-motor includes a base, a rotor and a retaining member. The base includes an axle tube. The rotor includes a rotary member and a support member arranged between the rotary member and the base. The rotary member has a central hole where the axle tube of the base extends. The retaining member is mounted on the base and surrounds the rotor. One end of the retaining member, which doesn't couple to the base, extends towards the axle tube to form a retaining portion. The retaining portion is within a rotational area of the rotor in an axial direction of the axle tube. The rotor is arranged between the retaining portion and the base. Accordingly, the retaining member can retain the rotor to prevent departure of the rotor from the axle tube of the base and the central structure of the micro-motor is effectively simplified.

### BACKGROUND OF THE INVENTION

1. Field of the Invention

The present invention relates to a motor and, more particularly, to a micro-motor that is fabricated using MEMS (micro-electromechanical systems).

2. Description of the Related Art

FIGS. 1 and 2 show a conventional micro-motor 90 including a base 91, a rotor 92 and an annular lid 93. An insulating layer 911 made of Si₃N₄ is formed on a surface of the base 91 by LPCVD (Low Pressure Chemical Vapor Deposition). And an axle tube 912 and two electrodes 913 are disposed on the insulating layer 911, with the annular lid 93 fixedly attaching to and being around the top end of the axle tube 912. The rotor 92 includes an inner ring 921 surrounding the axle tube 912 and adjacent to the annular lid 93, a plurality of actuators 922, an outer ring 923 connecting with the inner ring 921 by the actuators 922, and a support ring 924 fixed to a bottom of the inner ring 921 and abutting on the base 91. By this arrangement with a supporting effect of the support ring 924, the rotor 92 is able to rotate on the base 91. Furthermore, an inner diameter of the inner ring 921 is slightly larger than an outer diameter of the annular lid 93, and an inner diameter of the support ring 924 is smaller than the outer diameter of the annular lid 93, so that the support ring 92 is retained by the annular lid 93. Hence, the rotor 92 is prevented from disengaging from the axle tube 912 of the base 91 during rotation.

In use, a driving voltage is applied to the electrodes 913 to generate electrostatic force that results in deformation of the actuators 922, and then the actuators 922 return and complete a step motion after the driving voltage is removed. Therefore, rotation of the rotor 92 is achieved by repeating the above operation. Please note that concept of operation of a micro-motor is well known and is briefly depicted herein.

Generally, for avoiding departure of the rotor 92 from the base 91 by the annular lid 93 mounted to the top end of the axle tube 912, the inner ring 921 and the support ring 924 must be manufactured accurately in size to assure that the outer diameter of the annular lid 93 is larger than the inner diameter of the inner ring 921 but smaller than that of the support ring 924. However, the above-described central structure of the conventional micro-motor 90 is too complicated. If errors in sizes of the inner ring 921, the annular lid 93 and the support ring 924 are caused, or the inner ring 921, the annular lid 93 and the support ring 924 are at wrong positions relative to each other during manufacture of the conventional micro-motor 90, the rotor 92 will easily be stuck and that leads to impossibility of smooth rotation. Hence, difficulties in manufacturing and assembling the conventional micro-motor 90 are caused and there is a need for an improvement over the conventional micro-motor 90.

### SUMMARY OF THE INVENTION

It is therefore the primary objective of this invention to provide a micro-motor that has a simplified central structure to solve the problems of the conventional micro-motor.

A micro-motor according to the preferred teachings of the present invention includes a base, a rotor and a retaining member. The base includes an axle tube. The rotor includes a rotary member and a support member arranged between the rotary member and the base. The rotary member includes an inner ring, a plurality of actuators and an outer ring. The inner ring has a central hole where the axle tube of the base extends. Each actuator links between the inner ring and the outer ring. The retaining member is mounted on the base and surrounds the rotor. One end of the retaining member, which doesn't couple to the base, extends towards the axle tube to form a retaining portion. The retaining portion is within a rotational area of the rotor in an axial direction of the axle tube. The rotor is arranged between the retaining portion and the base, so that the retaining member is able to retain the rotor to prevent departure of the rotor from the axle tube of the base while the rotor is turning. Accordingly, by the arrangement of the retaining member surrounding the rotor, the central structure of the micro-motor is effectively simplified to enhance convenience of assembly and provide smooth rotation of the rotor.

In a most preferred form, the retaining member is a ring and the retaining portion is in the form of an annular flange formed on an inner periphery of the ring. Accordingly, the annular flange is able to retain the rotor to further avoid departure of the rotor from the axle tube of the base.

In a most preferred form, the retaining member is a ring and the retaining portion is in the form of a plurality of blocks formed on an inner periphery of the ring. Accordingly, a contact area between the retaining portion and the rotor is small if the rotor hits any one of the blocks while turning to reduce friction between the retaining portion and the rotor, so that life of the rotor is extended.

In a most preferred form, the support member is fixed to the outer ring of the rotary member. Accordingly, the central structure of the micro-motor is further simplified.

In a most preferred form, the support member is fixed to the outer ring of the rotary member, and there is another support member fixed to the inner ring of the rotary member. Accordingly, the two support members support the rotary member at the same time to further stabilize the rotation of the rotor.

In a most preferred form, the support member is a ring mounted around the axle tube, and a plurality of protrusions are formed on a bottom of the support member and abut on the base. Accordingly, the support member is in point contact with the base to improve rotation of the rotor on the base and reduce friction between the support member and the base.

In a most preferred form, the retaining member is a ring and the retaining portion is in the form of an annular flange formed on an inner periphery of the ring, with a plurality of protection protrusions being arranged between a top surface of the rotor and the annular flange. Accordingly, life of the rotor is extended.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view illustrating a conventional micro-motor;

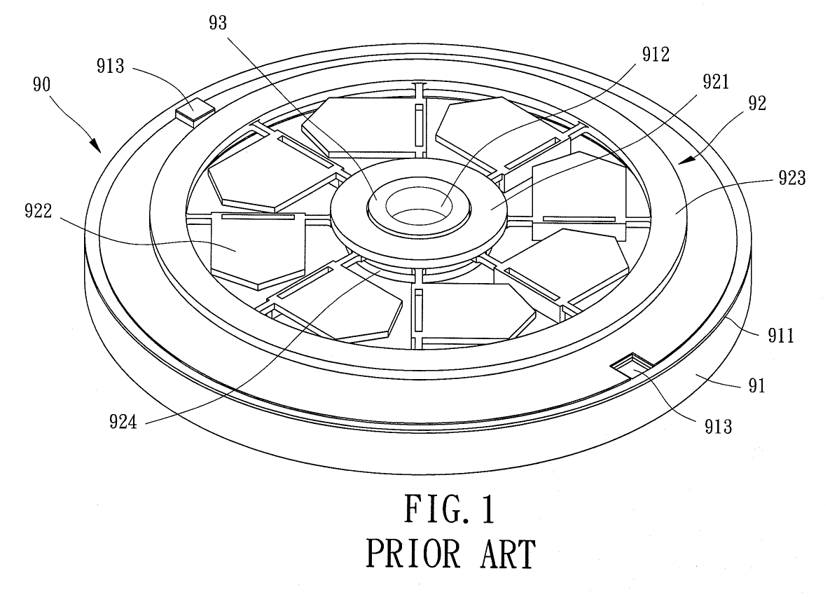

FIG. 2 is a cross sectional view of the conventional micro-motor of FIG. 1;

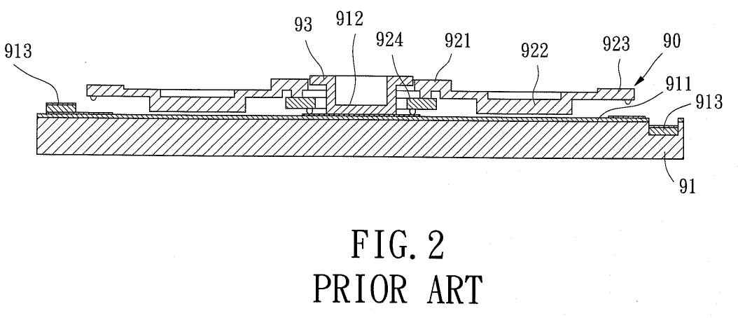

FIG. 3 is a perspective view illustrating a micro-motor according to the preferred teachings of the present invention;

FIG. 4 is a cross sectional view of the micro-motor of FIG. 3 according to section line 4-4 of FIG. 3;

FIG. 5 is a cross sectional view illustrating a micro-motor of a modified embodiment according to the preferred teachings of the present invention;

FIG. 6 is a perspective view illustrating a micro-motor of another modified embodiment according to the preferred teachings of the present invention;

FIG. 7 is a cross sectional view illustrating a micro-motor of a further modified embodiment according to the preferred teachings of the present invention; and

FIG. 8 is a perspective view illustrating the micro-motor of FIG. 7.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “end”, “portion”, “top”, “bottom”, “axial”, “annular”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

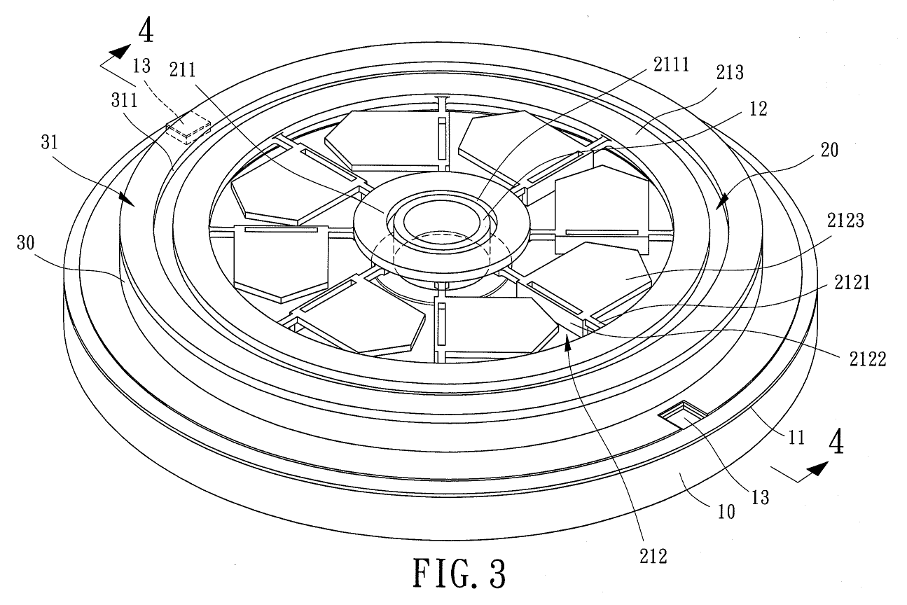

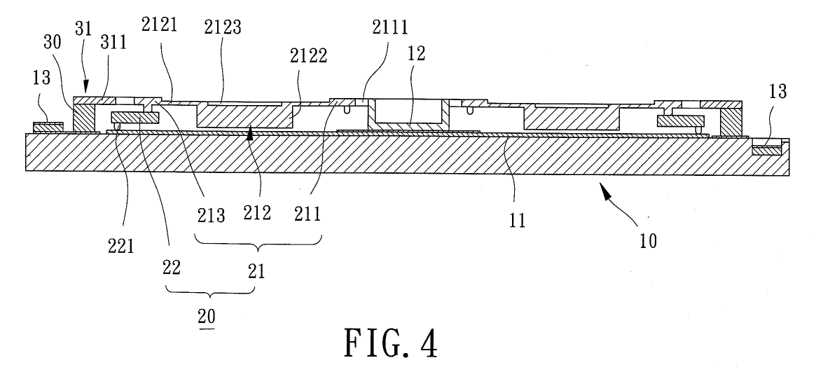

A micro-motor of a preferred embodiment according to the preferred teachings of the present invention is shown in FIGS. 3 and 4 of the drawings. According to the preferred embodiment form shown, the micro-motor includes a base 10, a rotor 20 rotatably mounted on the base 10, and a retaining member 30 mounted on the base 10 and surrounding the rotor 20, so that the rotor 20 is prevented from disengaging from the base 10 by the retaining member 30 while the rotor 20 is turning. The micro-motor of the present invention is characterized in that the central structure of the micro-motor is effectively simplified by the arrangement of the retaining member 30 surrounding the rotor 20 to enhance convenience of assembling and provide smooth rotation of the rotor 20.

An insulating layer 11 made of Si₃N₄ is formed on a surface of the base 10 of the present invention by LPCVD (Low Pressure Chemical Vapor Deposition), with an axle tube 12 and two electrodes 13 being disposed on the insulating layer 11.

The rotor 20 of the preferred embodiment according to the preferred teachings of the present invention includes a rotary member 21 and a support member 22. The rotary member 21 includes an inner ring 211 having a central hole 2111 where the axle tube 12 of the base 10 extends, a plurality of actuators 212 and an outer ring 213, with each actuator 212 having a connecting arm 2121 firmly linking between the inner ring 211 and the outer ring 213. Each of the actuators 212 further has a bushing 2122 and an actuating plate 2123 respectively fixed to two sides of the connecting arm 2121. The support member 22 is arranged between the rotary member 21 and the base 10, for supporting the rotary member 21 to keep a predetermined distance away from the base 10. Besides, the support member 22 is preferably in the form of a ring and a plurality of protrusions 221 are formed on a bottom of the support member 22. Thus, while the support member 22 is mounted around the axle tube 12 of the base 10, the protrusions 221 can abut on the insulating layer 11 of the base 10 and thus in point contact with the insulating layer 11 of the base 10, such that the rotor 20 is able to revolve smoothly about the axle tube 12 and on the base 10.

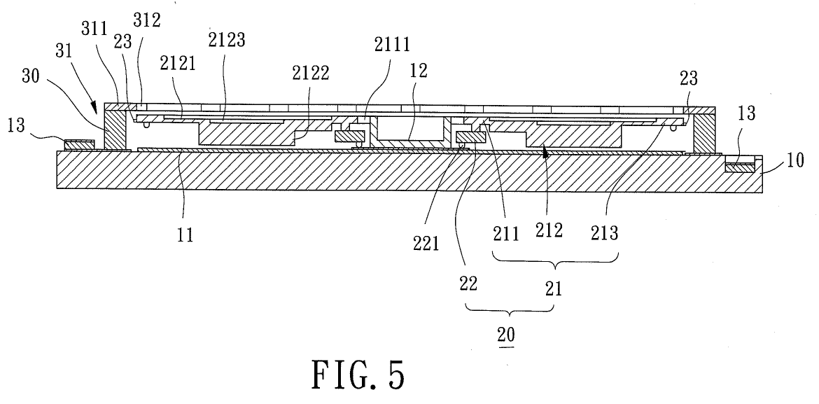

As shown in FIG. 4, the support member 22 is preferably fixed to a bottom of the outer ring 213 of the rotary member 21 to simplify the central structure of the micro-motor. Alternatively, the support member 22 can be fixed to a bottom of the inner ring 211 of the rotary member 21 according to needs of assembly, as shown in FIG. 5, or there are two support members 22 (not illustrated) fixed to the bottoms of the inner ring 211 and the outer ring 213 at the same time to further stabilize the rotation of the rotor 20.

The retaining member 30 of the preferred embodiment according to the preferred teachings of the present invention is mounted on the base 10 and surrounds the rotor 20. One end of the retaining member 30, which doesn't couple to the base 10, extends towards the axle tube 12 to form a retaining portion 31 above an outer edge of the rotor 20, so that the retaining portion 31 is within a rotational area of the rotor 20 in an axial direction of the axle tube 12, and the rotor 20 is arranged between the retaining portion 31 and the base 10. Besides, preferably, the retaining portion 31 is perpendicular to the axial direction of the axle tube 12.

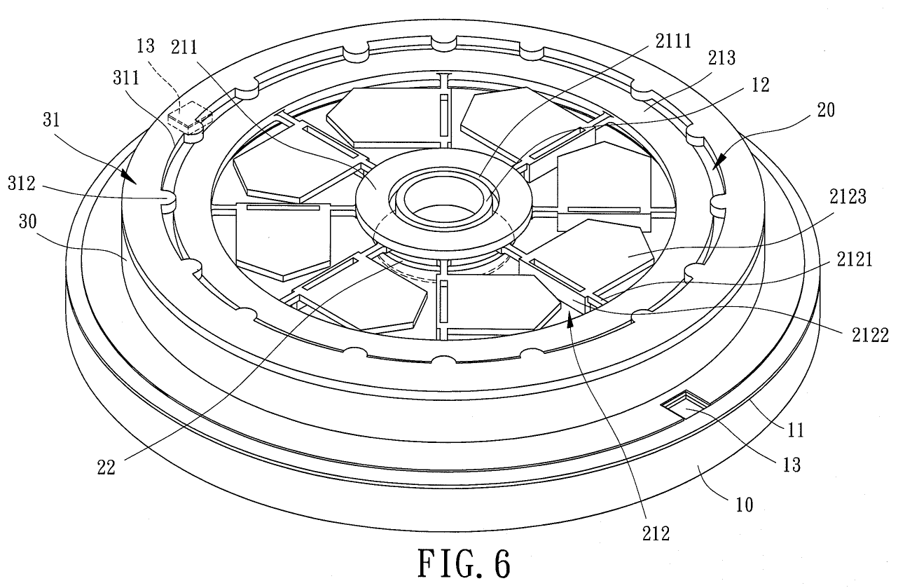

Referring to FIG. 3, the retaining member 30 is preferably a ring, and the retaining portion 31 can be in the form of an annular flange 311 formed on an inner periphery of the ring to retain the rotor 20 to not separate from the base 10 during rotation of the rotor 20. Alternatively, as shown in FIG. 6, the retaining portion 31 can be in the form of a plurality of blocks 312 formed on the inner periphery of the ring, so that a contact area between the retaining portion 31 and the rotor 20 is small if the rotor 20 hits any one of the blocks 312 while turning. Thus, friction between the retaining portion 31 and the rotor 20 is also small, and, hence, life of the micro-motor is extended. Moreover, it is noted that the retaining portion 31 can optionally extend to be within an axially rotational area of any component of the rotor 20 according to needs of use. Referring to FIG. 4, when the support member 22 is fixed to the outer ring 213 of the rotary member 21, the retaining portion 31 preferably extends to be within a rotational area of the support member 22 of the rotor 20 in the axial direction of the axle tube 12, so that the support member 22 of the rotor 20 is between the retaining portion 31 and the base 10. Alternatively, the outer ring 213 of the rotor 20 is between the retaining portion 31 and the base 10, when the support member 22 is not fixed to the outer ring 213 and the retaining portion 31 preferably extends to be within a rotational area of the outer ring 213 of the rotor 20 in the axial direction of the axle tube 12, as shown in FIG. 6.

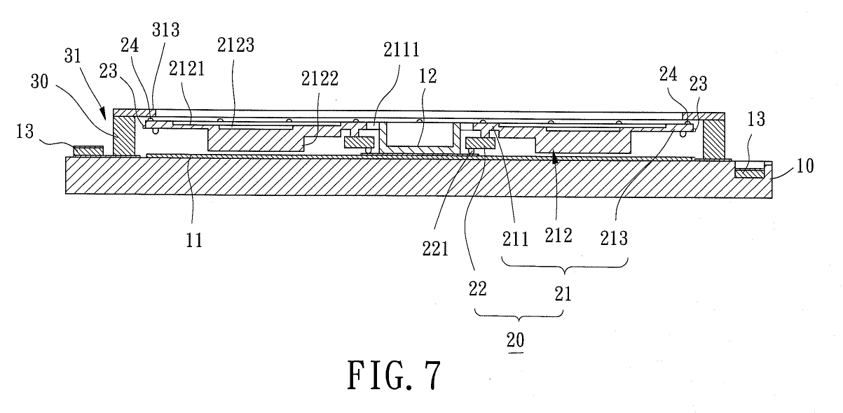

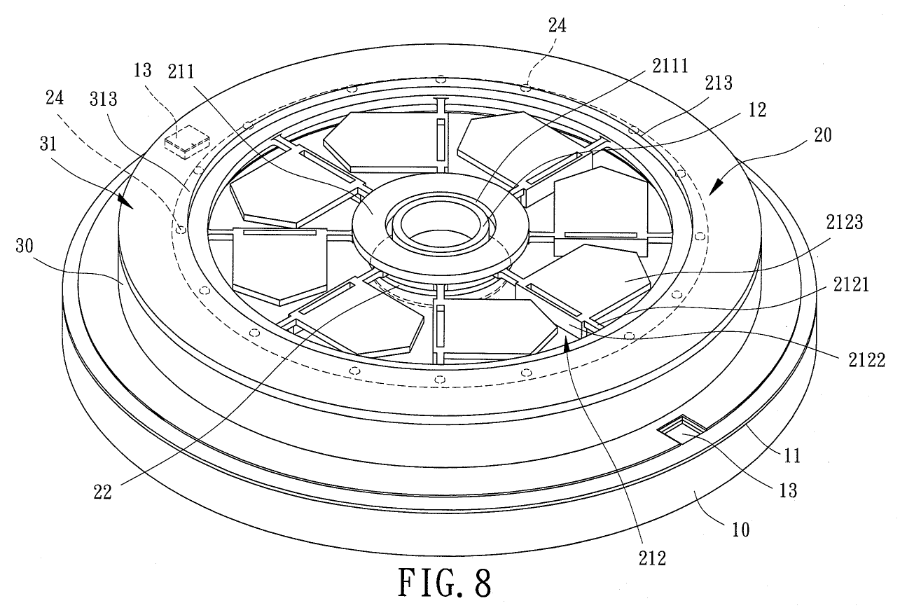

Referring to FIGS. 7 and 8, the retaining member 30 is selected from a ring and the retaining portion 31 is in the form of an annular flange 313 formed on the inner periphery of the ring, with the support member 22 being fixed to the inner ring 211 of the rotary member 21. By this arrangement, departure of the rotor 20 from the axle tube 12 of the base 10 is avoided effectively by the annular flange 313. Additionally, a plurality of first protection protrusions 24 is arranged between a top surface of the rotor 20 and the annular flange 313 to reduce a contact area between them. In detail, the first protection protrusions 24 are spacedly formed on a top surface of the outer ring 213 and between the outer ring 213 and the annular flange 313, so that while the annular flange 313 hits the first protection protrusions 24, the rotor 20 is in point contact with the annular flange 313 through the first protection protrusions 24 to reduce friction against each other. Therefore, life of the micro-motor of the present invention is prolonged.

In use, a driving voltage is applied to the electrodes 13 to generate electrostatic force that results in deformation of the actuating plates 2123 of the actuators 212. After the driving voltage is removed, each actuator 212 returns and completes a step motion by the actuating plate 2123 constructed with the connecting arm 2121 and the bushing 2122, so as to drive the rotor 20 to rotate. Since the retaining portion 31 of the retaining member 30 extends to the rotational area of the rotor 20 in the axial direction of the axle tube 12, the retaining portion 31 is able to retain the rotor 20 to prevent departure of the rotor 20 from the axle tube 12 of the base 10 while the rotor 20 is turning. Besides, referring again to FIG. 5, the outer ring 213 has plural second protection protrusions 23 formed on an outer periphery thereof to avoid hitting the retaining member 30 directly during rotation of the rotor 20.

As has been discussed above, the central structure of the micro-motor is simplified and the retaining member 30 is easily positioned at a right position on the base 10 and relative to the rotor 20, since the retaining member 30 is mounted on the base 10 and around the rotor 20. Consequently, convenience of assembling is provided and the rotor 20 is prevented from being stuck to smoothly rotate, so that the quality of the micro-motor is improved.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A micro-motor comprising:
a base including an axle tube;
a rotor including a rotary member and a support member arranged between the rotary member and the base, with the rotary member including an inner ring having a central hole where the axle tube of the base extends, a plurality of actuators, and an outer ring, with each actuator linking between the inner ring and the outer ring; and
a retaining member being mounted on the base and surrounding the rotor, with one end of the retaining member, which doesn't couple to the base, extending towards the axle tube to form a retaining portion, with the retaining portion being within a rotational area of the rotor in an axial direction of the axle tube, with the rotor being arranged between the retaining portion and the base.

2. The micro-motor as defined in claim 1, wherein the retaining member is a ring and the retaining portion is in the form of an annular flange formed on an inner periphery of the ring.

3. The micro-motor as defined in claim 1, wherein the retaining member is a ring and the retaining portion is in the form of a plurality of blocks formed on an inner periphery of the ring.

4. The micro-motor as defined in claim 1, wherein the support member is fixed to the outer ring of the rotary member.

5. The micro-motor as defined in claim 4, wherein the retaining portion extends to be within a rotational area of the support member of the rotor in the axial direction of the axle tube, with the support member being arranged between the retaining portion and the base.

6. The micro-motor as defined in claim 4, wherein the retaining portion extends to be within a rotational area of the outer ring of the rotor in the axial direction of the axle tube, with the outer ring being arranged between the retaining portion and the base.

7. The micro-motor as defined in claim 1, wherein the support member is fixed to the inner ring of the rotary member.

8. The micro-motor as defined in claim 7, wherein the retaining portion extends to be within a rotational area of the outer ring of the rotor in the axial direction of the axle tube, with the outer ring being arranged between the retaining portion and the base.

9. The micro-motor as defined in claim 1, wherein the support member is fixed to the outer ring of the rotary member, and there is another support member fixed to the inner ring of the rotary member.

10. The micro-motor as defined in claim 9, wherein the retaining portion extends to be within a rotational area of the support member of the rotor in the axial direction of the axle tube, with the support member being arranged between the retaining portion and the base.

11. The micro-motor as defined in claim 9, wherein the retaining portion extends to be within a rotational area of the outer ring of the rotor in the axial direction of the axle tube, with the outer ring being arranged between the retaining portion and the base.

12. The micro-motor as defined in claim 1, wherein the support member is a ring mounted around the axle tube, and a plurality of protrusions are formed on a bottom of the support member and abut on the base.

13. The micro-motor as defined in claim 1, wherein the retaining member is a ring and the retaining portion is in the form of an annular flange formed on an inner periphery of the ring, with a plurality of protection protrusions being arranged between a top surface of the rotor and the annular flange.
